(19) United States
(12) Patent Application Publication
(10) Pub. No.: US 2023/0379078 A1
(43) Pub. Date: Nov. 23, 2023

(54) OPTICAL TRANSMISSION APPARATUS AND OPTICAL TRANSMISSION METHOD

(71) Applicant: Fujitsu Limited, Kawasaki-shi (JP)

(72) Inventors: Yusuke TANABE, Sendai (JP); Nobuyuki AKIZAWA, Kawasaki (JP)

(73) Assignee: Fujitsu Limited, Kawasaki-shi (JP)

(21) Appl. No.: 18/159,105

(22) Filed: Jan. 25, 2023

(30) Foreign Application Priority Data
May 23, 2022 (JP) 2022-083684

(51) Int. Cl. H04L 1/00; H04B 10/516

(52) U.S. Cl. CPC H04L 1/0041; H04B 10/516

(57) ABSTRACT

An optical transmission apparatus includes: a first processing circuit that performs, on a forward error correction (FEC) frame obtained by adding FEC to a frame that directly accommodates a client signal, error correction based on the FEC, and acquires an amount of errors for which correction failed in the error correction as an uncorrectable amount; and a second processing circuit that estimates the number of bit errors of the errors based on the uncorrectable amount, and outputs information that includes the estimated number of bit errors.

### CROSS-REFERENCE TO RELATED APPLICATION

This application is based upon and claims the benefit of priority of the prior Japanese Patent Application No. 2022-83684, filed on May 23, 2022, the entire contents of which are incorporated herein by reference.

### FIELD

The embodiment discussed herein is related to an optical transmission apparatus and an optical transmission method.

### BACKGROUND

In backbone communication networks, an optical transmission standard called an optical transport network (OTN) recommended by the International Telecommunication Union-Telecommunication Standardization Sector (ITU-T), which is an international standardization organization, is widely used.

Japanese Laid-open Patent Publication No. 2017-059892 and International Publication Pamphlet No. WO 2015/133288 are disclosed as related art.

### SUMMARY

According to an aspect of the embodiments, an optical transmission apparatus includes: a first processing circuit that performs, on a forward error correction (FEC) frame obtained by adding FEC to a frame that directly accommodates a client signal, error correction based on the FEC, and acquires an amount of errors for which correction failed in the error correction as an uncorrectable amount; and a second processing circuit that estimates the number of bit errors of the errors based on the uncorrectable amount, and outputs information that includes the estimated number of bit errors.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an example of an optical transmission system;

FIG. 2A is a diagram for describing an example of an optical transport network (OTN) frame;

FIG. 2B is a diagram for describing an example of a direct accommodation frame;

FIG. 3A is a block diagram illustrating an example of a hardware configuration of an optical transmission apparatus;

FIG. 3B is a block diagram illustrating an example of a functional configuration of the optical transmission apparatus;

FIG. 4 is a block diagram illustrating an example of a functional configuration of a transmission unit;

FIG. 5A is a diagram for describing an example of the OTN frame in a case where all errors may be corrected by a forward error correction (FEC) decoder;

FIG. 5B is a diagram for describing an example of the direct accommodation frame in a case where all errors may be corrected by the FEC decoder;

FIG. 6A is a diagram for describing an example of the OTN frame in a case where all errors may not be corrected by the FEC decoder;

FIG. 6B is a diagram for describing an example of the direct accommodation frame in a case where all errors may not be corrected by the FEC decoder;

FIG. 7 is a diagram for describing an example of a unit block of an FEC frame and patterns of errors that may not be corrected;

FIG. 8 is a block diagram illustrating an example of a functional configuration of an assist unit and a control unit;

FIG. 9 is an example of a pseudo frame;

FIG. 10 is an example of a data structure of the direct accommodation frame;

FIG. 11 is an example of a processing sequence diagram for the OTN frame;

FIG. 12 is an example of a processing sequence diagram for the direct accommodation frame; and

FIG. 13 is a graph illustrating a relationship between a transmission distance and a data rate.

### DESCRIPTION OF EMBODIMENTS

The OTN specifies a bit rate, a mapping method, and the like for accommodating and transparently transferring various client signals. Note that the various client signals include, for example, signals of monitoring and control systems that are conscious of management of wavelength division multiplex (WDM) signals, Ethernet (registered trademark), synchronous digital hierarchy (SDH), and the like.

Meanwhile, OTN frames are often used for communication carriers who need high reliability and maintainability. From a viewpoint of ensuring such reliability and maintainability, the OTN frame includes information regarding bit errors (for example, the number of bit errors). This information regarding bit errors may be detected by an error detection function such as bit interleaved parity (BIP).

On the other hand, in a private network coupling one company's data centers, it is effective to use another frame with higher transmission efficiency than the OTN frame in addition to the OTN frame for the purpose of improving transmission performance. For example, a frame called an OpenZR+ frame has high accommodation efficiency because it directly accommodates client signals, resulting in improved transmission efficiency compared to the OTN frame.

However, such a signal-direct-accommodating type frame, which directly accommodates the client signals, does not include the information regarding bit errors from the viewpoint of aiming to improve the transmission efficiency. Thus, even when the error detection function such as the BIP is implemented in an optical transmission apparatus, the optical transmission apparatus is not possible to detect the information regarding bit errors from the signal-direct-accommodating type frame.

Here, the optical transmission apparatus includes a large-scale integration (LSI), a field programmable gate array (FPGA), a central processing unit (CPU), and the like, and transmission processing that needs high speed such as optical signal processing and frame processing is often performed by the LSI. On the other hand, since assist processing, which improves frame reliability and maintainability, does not need as high speed as the transmission processing, the assist processing is often performed by the FPGA using information stored in an over head (OH) area of the frame. Thus, for example, it is also assumed that the information regarding bit errors is stored in a reserve area of the OH area included in the signal-direct-accommodating type frame, and the FPGA performs processing such as the BIP on this information.

However, due to a difference in processing speed between the LSI and the FPGA, it is not possible to transfer the frame itself from the LSI to the FPGA. Thus, it is extremely difficult to store the information regarding bit errors in the reserve area of the OH area included in the signal-direct-accommodating type frame, and perform, by the FPGA, the processing such as the BIP on this information.

Therefore, in one aspect, it is an object to provide an optical transmission apparatus and an optical transmission method that acquire information equivalent to a result of BIP even for a frame that directly accommodates a client signal.

Hereinafter, modes for carrying out the present embodiment will be described with reference to the drawings.

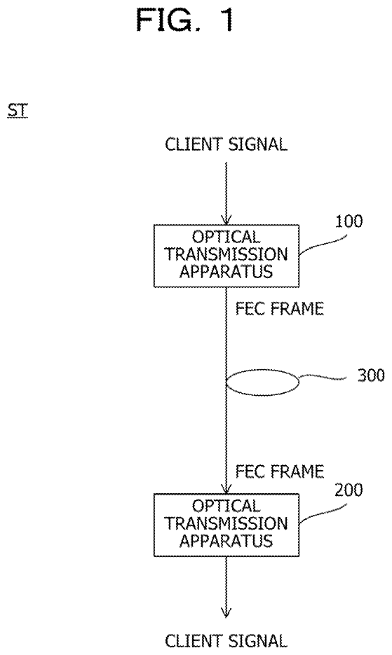

As illustrated in FIG. 1, an optical transmission system ST includes an optical transmission apparatus 100 on a transmission side and an optical transmission apparatus 200 on a reception side. The optical transmission apparatuses 100 and 200 are coupled to each other via an optical transmission line 300. The optical transmission line 300 includes, for example, an optical fiber.

The optical transmission apparatus 100 receives an electrical client signal in a digital format from a client network. The client signal is, for example, an Ethernet (registered trademark) signal. The client signal may be a main signal or a control signal including only parameters for adjusting transmission characteristics and the like. The optical transmission apparatus 100 converts the received client signal into an electrical transmission frame based on setting for the optical transmission apparatus 100.

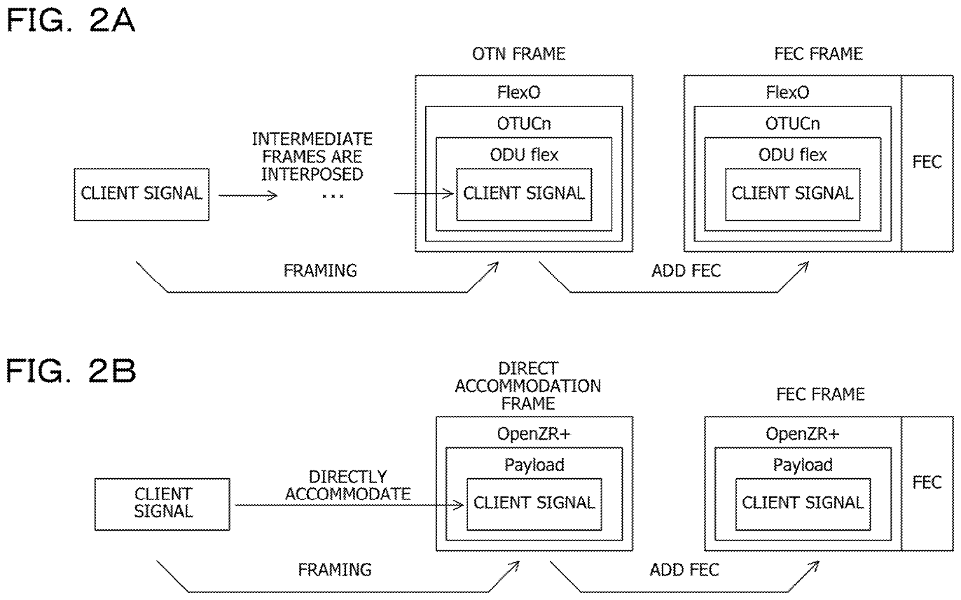

For example, as illustrated in FIG. 2A, the optical transmission apparatus 100 converts, based on the setting, the client signal into a transmission frame such as an optical transport network (OTN) frame (for example, an OTN Optical channel Transport Unit-Cn (OTUCn)/Flexible OTN (FlexO) frame). The conversion of the client signal into the transmission frame may be rephrased as mapping of the client signal to the transmission frame. The conversion from the client signal into the OTN frame is performed in stages. For example, various intermediate frames are interposed before the client signal is converted into the OTN frame.

For example, the client signal is physical coding sublayer (PCS)-converted at a PCS layer and then converted into an Optical channel Data Unit flexible (ODUflex) frame including the PCS-converted client signal. Thereafter, the ODUflex frame is converted into an OTUCn frame including the ODUflex frame, and the OTUCn frame is converted into an OTN frame including the OTUCn frame. When the client signal is 400 Gigabit Ethernet (registered trademark) (GbE), a redundancy rate of data is about 5.2%.

On the other hand, as illustrated in FIG. 2B, the optical transmission apparatus 100 directly converts, based on the setting, the client signal into a transmission frame such as a signal-direct-accommodating type frame (hereinafter referred to as a direct accommodation frame). This direct conversion may be rephrased as direct mapping. In FIG. 2B, an OpenZR+ frame is indicated as an example of the direct accommodation frame. Although details will be described later, the OpenZR+ frame includes a frame structure standardized as an optical transmission standard called OpenZR+. The direct accommodation frame may be an OpenZR+ extension frame obtained by extending an accommodation rate without changing the frame structure of the OpenZR+ frame. As described above, the conversion from the client signal into the direct accommodation frame is directly performed. For example, no intermediate frame is interposed before the client signal is converted into the OTN frame. With this configuration, when the client signal is 400 GbE, the redundancy rate of the data is only about 0.4%.

The OpenZR+ is standardized by OpenZR+ Multi-Source Agreement (MSA) for transmitting 100 GbE, 200 GbE, and 400 GbE client signals at a single wavelength. The OpenZR+ frame has transmission performance of 400 Gbps, while the OpenZR+ extension frame has transmission performance of 800 Gbps or 1 Tbps. In this way, the direct accommodation frame such as the OpenZR+ frame and the OpenZR+ extension frame may directly perform multiplex accommodation of the 100 GbE, 200 GbE, and 400 GbE client signals.

Returning to FIG. 1, when the client signal is converted into the transmission frame, the optical transmission apparatus 100 generates forward error correction (FEC), which is an error correction code, and adds the FEC to the transmission frame as illustrated in FIGS. 2A and 2B. A type of the FEC is not particularly limited, and may be, for example, concatenated FEC (CFEC) or open FEC (OFEC). By adding the FEC to the transmission frame, the optical transmission apparatus 100 generates an FEC frame. When the FEC frame is generated, the optical transmission apparatus 100 converts the FEC frame from an electrical signal to an optical signal, and transmits the FEC frame as the optical signal to the optical transmission apparatus 200.

The optical transmission apparatus 200 receives the FEC frame as the optical signal transmitted from the optical transmission apparatus 100 and passed through the optical transmission line 300. When the FEC frame is received, the optical transmission apparatus 200 converts the FEC frame from the optical signal into the electrical signal, extracts the FEC from the FEC frame, and performs error correction. When the optical transmission apparatus 200 performs the error correction, the optical transmission apparatus 200 converts the FEC frame into the transmission frame based on setting for the optical transmission apparatus 200. For example, the optical transmission apparatus 200 converts, based on the setting, the FEC frame into a transmission frame such as an OTN frame. Furthermore, the optical transmission apparatus 200 converts, based on the setting, the FEC frame into a transmission frame such as a direct accommodation frame. When the FEC frame is converted into the transmission frame, the optical transmission apparatus 200 converts the transmission frame into a client signal and transmits the client signal to the client network.

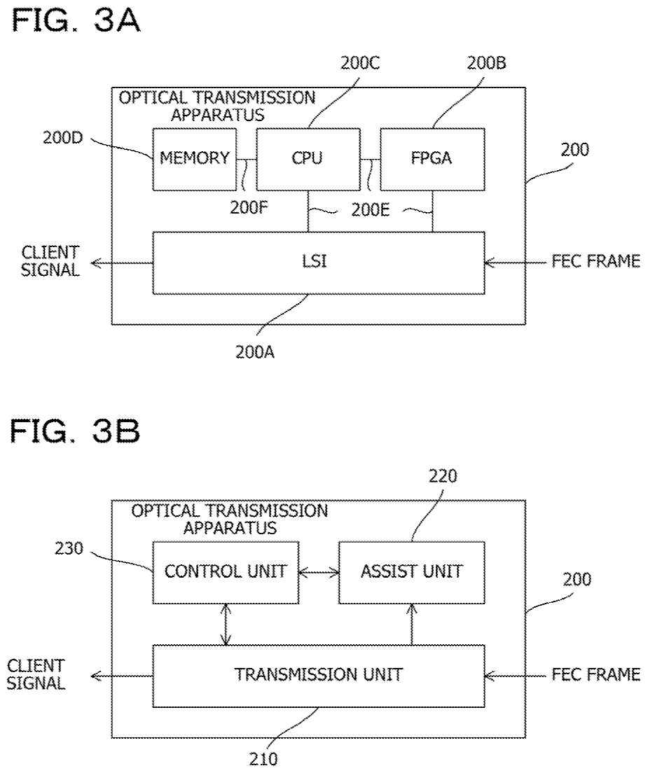

With reference to FIGS. 3A and 3B, details of a configuration of the optical transmission apparatus 200 will be described. Note that, since the optical transmission apparatus 100 basically has a configuration similar to that of the optical transmission apparatus 200, detailed description thereof will be omitted.

First, as illustrated in FIG. 3A, the optical transmission apparatus 200 includes a large-scale integration (LSI) 200A, a field programmable gate array (FPGA) 200B, a central processing unit (CPU) 200C, and a memory 200D as hardware circuits. A hardware circuit such as a digital signal processor (DSP) or an application specific integrated circuit (ASIC) may be adopted instead of the LSI 200A. The LSI 200A may include the DSP. Note that the memory includes either one or both of a random access memory (RAM) and a read only memory (ROM). A processing speed of the LSI 200A is higher than that of the FPGA 200B.

The LSI 200A, the FPGA 200B, and the CPU 200C are coupled to each other by an internal bus 200E. The CPU 200C is coupled to the memory 200D by an internal bus 200F. Note that each of the LSI 200A, the FPGA 200B, and the CPU 200C implements a function described later, and also executes various types of processing according to processing sequence diagrams described later. For example, the CPU 200C implements the function and also executes the processing by a program stored in the memory 200D.

Next, as illustrated in FIG. 3B, the optical transmission apparatus 200 includes a transmission unit 210, an assist unit 220, and a control unit 230. The transmission unit 210 may be implemented by the LSI 200A described above. The assist unit 220 may be implemented by the FPGA 200B described above. The control unit 230 may be implemented by the CPU 200C and the memory 200D described above. Therefore, the transmission unit 210, the assist unit 220, and the control unit 230 are coupled to each other.

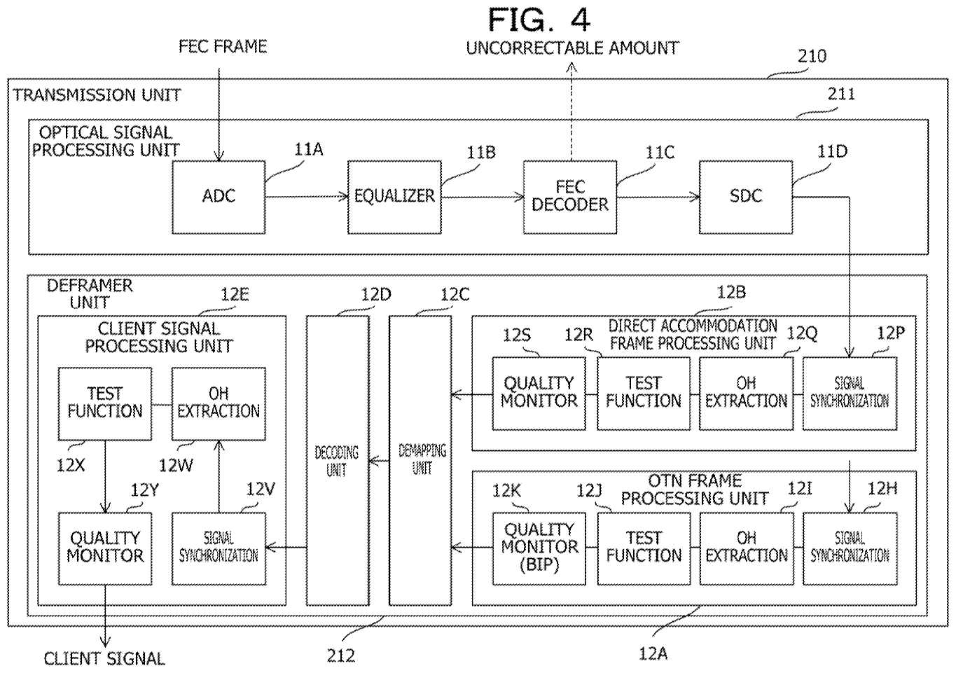

With reference to FIGS. 4 to 7, details of the transmission unit 210 will be described.

As illustrated in FIG. 4, the transmission unit 210 includes an optical signal processing unit 211 and a deframer unit 212. The optical signal processing unit 211 is an example of a first processing circuit. The optical signal processing unit 211 includes an analogue digital converter (ADC) 11A, an equalizer 11B, an FEC decoder 11C, a symbol data converter (SDC) 11D, and the like. For example, the optical signal processing unit 211 also includes an integrated coherent receiver (ICR), analogue coherent optics (ACO), or the like that receives an FEC frame as an optical signal from the optical transmission line 300 by local light emission, converts the received FEC frame into an electrical FEC frame, and outputs the electrical FEC frame to the ADC 11A. Note that details of the deframer unit 212 will be described later.

The ADC 11A converts the FEC frame as the electrical signal input from the ICR from an analogue format to the digital format, and outputs the FEC frame in the digital format to the equalizer 11B. The equalizer 11B compensates the FEC frame for losses caused in the optical transmission apparatus 100, the optical transmission apparatus 200, and the optical transmission line 300, and outputs the compensated FEC frame to the FEC decoder 11C.

The FEC decoder 11C extracts FEC from the FEC frame, and performs error correction according to a type of the FEC. Although details will be described later, for example, when an object to be processed by the optical transmission apparatus 200 is a direct accommodation frame by the setting and the FEC frame includes OFEC, error correction according to the OFEC is performed, and the number of blocks for which errors may not be corrected is acquired based on the OFEC and output to the assist unit 220. When the error correction ends, the FEC decoder 11C outputs the FEC frame after the error correction to the SDC 11D.

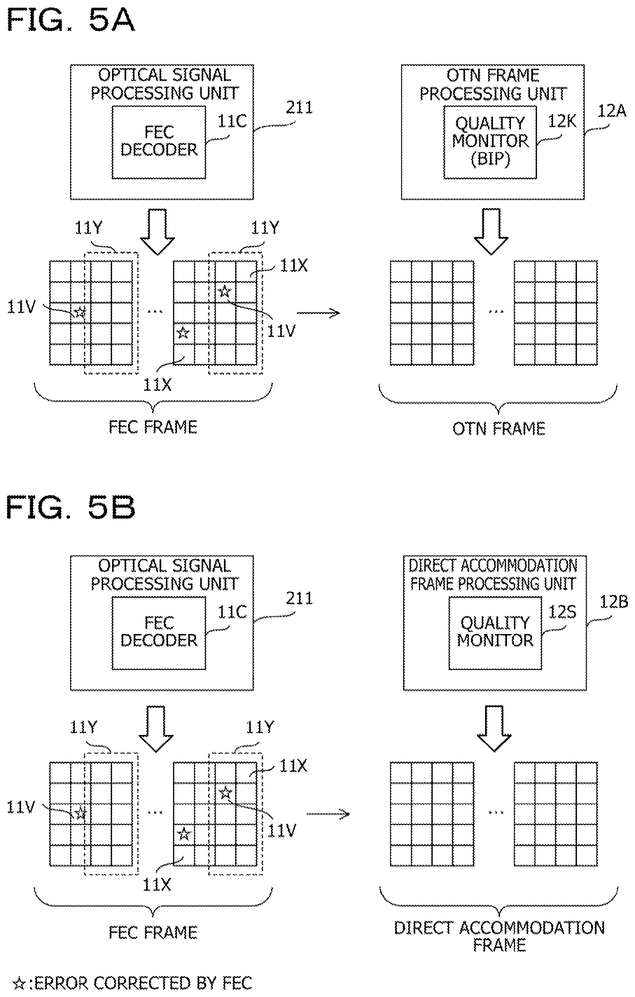

Here, as illustrated in FIGS. 5A and 5B, the FEC frame includes a plurality of symbols 11X. The FEC decoder 11C specifies a unit block 11Y according to the type of the FEC from the FEC frame, and individually performs error correction on the symbol 11X included in the specified unit block 11Y.

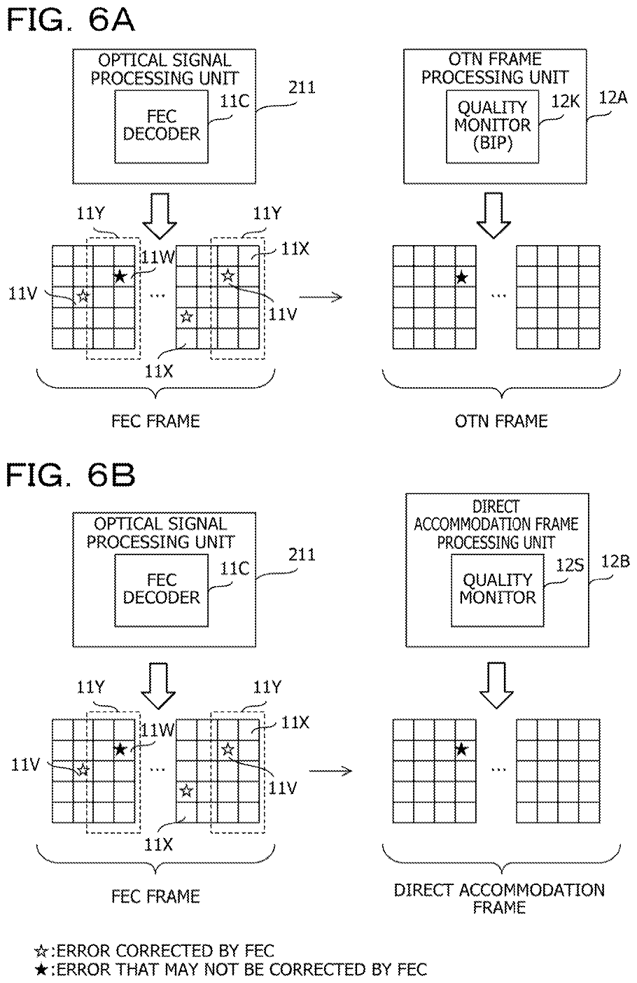

As illustrated in FIGS. 5A and 5B, depending on the FEC frame, even when errors occur, the FEC decoder 11C may correct all errors as a result of performing error correction. In FIGS. 5A and 5B, symbols 11V with the errors corrected are indicated by white star marks. On the other hand, as illustrated in FIGS. 6A and 6B, depending on the FEC frame, even when error correction is performed, the FEC decoder 11C may not correct all errors. In FIGS. 6A and 6B, a symbol 11W for which the error may not be corrected is indicated by a black star mark. In this case, the FEC frame includes not only the symbols 11V with the errors corrected based on the FEC, but also the symbol 11W for which the error may not be corrected.

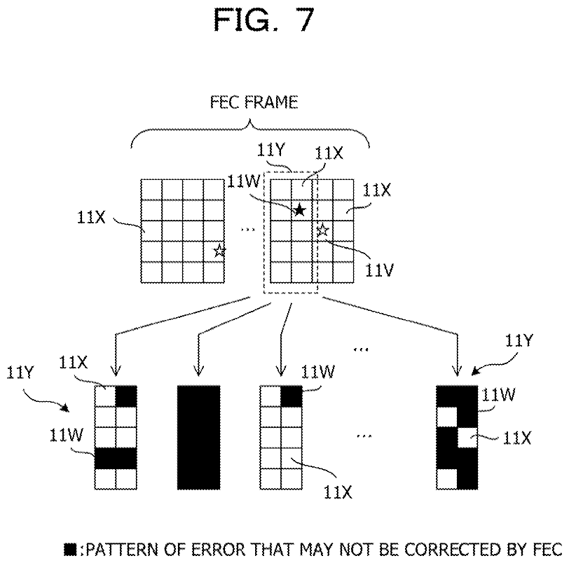

In this way, even when there is the symbol 11W for which the error may not be corrected, it is not possible for the FEC decoder 11C to accurately specify the number of symbols of the symbol 11W. For example, as illustrated in FIG. 7, even when there is one symbol 11W or a plurality of symbols 11W in the unit block 11Y, it is not possible for the FEC decoder 11C to specify the number of symbols of the symbol 11W. Thus, regardless of the number of symbols, the FEC decoder 11C outputs the number of block errors, which is the number of blocks of the unit block 11Y including the symbol 11W for which the error may not be corrected, to the assist unit 220 as an uncorrectable amount. The number of blocks per second of the unit blocks 11Y including the symbol 11W for which the error may not be corrected is about several dozens, and it is assumed that an error occurrence frequency is sufficiently low. With this configuration, in the present embodiment, one symbol error is approximated to one block error. As a result, the FEC decoder 11C may output the number of block errors as the uncorrectable amount faster than in the case of no approximation.

Returning to FIG. 4, the SDC 11D converts the plurality of symbols included in the FEC frame into data according to the symbols, and outputs a transmission frame including the data obtained by converting the symbols to the deframer unit 212 based on the setting for the optical transmission apparatus 200. For example, the SDC 11D outputs an OTN frame or a direct accommodation frame including the data obtained by converting the symbols based on the setting.

The deframer unit 212 includes an OTN frame processing unit 12A, a direct accommodation frame processing unit 12B, a demapping unit 12C, a decoding unit 12D, and a client signal processing unit 12E. The OTN frame processing unit 12A receives the OTN frame output from the SDC 11D. The direct accommodation frame processing unit 12B receives the direct accommodation frame output from the SDC 11D.

First, details of the OTN frame processing unit 12A will be described. The OTN frame processing unit 12A includes a signal synchronization unit 12H, an over head (OH) extraction unit 12I, a test function unit 12J, and a quality monitor unit 12K. The signal synchronization unit 12H receives the OTN frame output from the SDC 11D. When receiving the OTN frame, the signal synchronization unit 12H executes synchronization processing. For example, the signal synchronization unit 12H detects synchronization information of the OTN frame, establishes synchronization with the OTN frame based on the detected synchronization information, and outputs the OTN frame to the OH extraction unit 12I. The OH extraction unit 12I extracts an OH area of the OTN frame, and outputs the extracted OH area to the test function unit 12J. The test function unit 12J executes known test processing. For example, the test function unit 12J determines whether or not there is a predetermined test flag in any set area (for example, reserve (RES) or the like) in the OH area. The quality monitor unit 12K confirms quality of the OTN frame. For example, the quality monitor unit 12K includes a bit interleaved parity (BIP) function, and detects information regarding bit errors (for example, the number of bit errors) by the BIP function.

Here, as illustrated in FIG. 5A, when the FEC decoder 11C may correct all errors, the quality monitor unit 12K determines that there is no problem with the quality of the OTN frame even when the BIP function is performed. In this case, when the quality of the OTN frame is confirmed, the quality monitor unit 12K outputs the OTN frame to the demapping unit 12C. On the other hand, as illustrated in FIG. 6A, even when the FEC decoder 11C may not correct all errors, the quality monitor unit 12K may detect the number of bit errors and determine that there is a problem with the quality of the OTN frame when the BIP function is performed. In this case, for example, after storing the number of bit errors in the OTN frame, the OTN frame may be output to the demapping unit 12C. In this way, in the case of the OTN frame, whether the quality of the OTN frame is good or bad is determined by performing the BIP function.

Next, details of the direct accommodation frame processing unit 12B will be described. The direct accommodation frame processing unit 12B includes a signal synchronization unit 12P, an OH extraction unit 12Q, a test function unit 12R, and a quality monitor unit 12S. The signal synchronization unit 12P receives the direct accommodation frame output from the SDC 11D. When receiving the direct accommodation frame, the signal synchronization unit 12P establishes synchronization between the signal synchronization unit 12H and the direct accommodation frame, and outputs the direct accommodation frame to the OH extraction unit 12Q. The OH extraction unit 12Q extracts an OH area of the direct accommodation frame, and outputs the extracted OH area to the test function unit 12R. The test function unit 12R determines whether or not there is a predetermined test flag in any set area (for example, RES or the like) in the OH area. The quality monitor unit 12S confirms quality of the direct accommodation frame. Unlike the quality monitor unit 12K, the quality monitor unit 12S does not have the BIP function. Thus, it is not possible for the quality monitor unit 12S to detect information regarding bit errors.

Here, even when the quality monitor unit 12S does not have the BIP function, as illustrated in FIG. 5B, when the FEC decoder 11C may correct all errors, the quality monitor unit 12S may determine that there is no problem with the quality of the direct accommodation frame. In this case, when the quality of the direct accommodation frame is confirmed, the quality monitor unit 12S outputs the direct accommodation frame to the demapping unit 12C. On the other hand, as illustrated in FIG. 6B, in a case where the FEC decoder 11C may not correct all errors, it is not possible for the quality monitor unit 12S to detect the number of bit errors and determine whether the quality of the direct accommodation frame is good or bad, because the quality monitor unit 12S does not have the BIP function. In this way, the quality monitor unit 12S may not detect information regarding bit errors in the case of the direct accommodation frame. Therefore, although details will be described later, in such a case, a function equivalent to the BIP function is implemented by the assist unit 220 also for the direct accommodation frame.

The demapping unit 12C receives the OTN frame output from the quality monitor unit 12K. When receiving the OTN frame, the demapping unit 12C converts the OTN frame into a client signal in a processing procedure opposite to the processing procedure illustrated in FIG. 2A. The conversion of the OTN frame into the client signal may be rephrased as demapping of the OTN frame to the client signal. Furthermore, the demapping unit 12C receives the direct accommodation frame output from the quality monitor unit 12S. When receiving the direct accommodation frame, the demapping unit 12C converts the direct accommodation frame into a client signal in a processing procedure opposite to the processing procedure illustrated in FIG. 2B. The conversion of the direct accommodation frame into the client signal may be rephrased as direct demapping of the direct accommodation frame into the client signal. The demapping unit 12C outputs the client signal to the decoding unit 12D.

The decoding unit 12D decodes, when the client signal is encrypted by the optical transmission apparatus 100 on the transmission side, the encrypted client signal, and outputs the decoded client signal to the client signal processing unit 12E. The client signal processing unit 12E receives the client signal.

The client signal processing unit 12E includes a signal synchronization unit 12V, an OH extraction unit 12W, a test function unit 12X, and a quality monitor unit 12Y. The signal synchronization unit 12V receives the client signal output from the decoding unit 12D. When receiving the client signal, the signal synchronization unit 12V executes synchronization processing. For example, the signal synchronization unit 12V detects synchronization information of the client signal, establishes synchronization with the client signal based on the detected synchronization information, and outputs the client signal to the OH extraction unit 12W. The OH extraction unit 12W extracts an OH area of the client signal, and outputs the extracted OH area to the test function unit 12X. The test function unit 12X determines whether or not there is a predetermined test flag in any set area in the OH area. The quality monitor unit 12Y confirms quality of the client signal. When the quality of the client signal is confirmed, the quality monitor unit 12Y transmits the client signal to the client network.

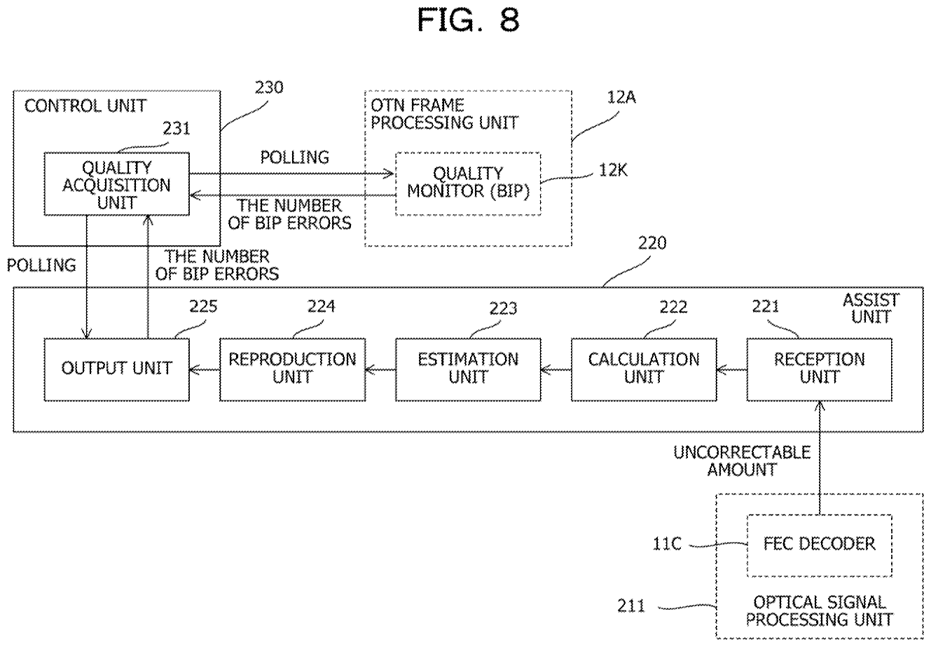

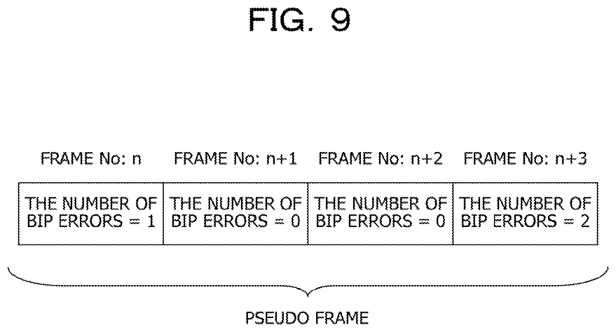

The assist unit 220 and the control unit 230 will be described with reference to FIGS. 8 and 9.

The assist unit 220 is an example of a second processing circuit. The assist unit 220 assists processing that is difficult to process in the transmission unit 210. The assist unit 220 includes a reception unit 221, a calculation unit 222, an estimation unit 223, a reproduction unit 224, and an output unit 225. The control unit 230 includes a quality acquisition unit 231.

The reception unit 221 receives the uncorrectable amount output from the FEC decoder 11C. The calculation unit 222 calculates a symbol error rate based on the number of block errors as the uncorrectable amount received by reception unit 221, a predetermined calculation expression, the type of the FEC, and the like. As described above, since one block error is approximated to one symbol error, the predetermined calculation expression may be defined as follows as an example. Note that the number of blocks included in one FEC frame may be specified based on, for example, the type of the FEC, or the like.

Calculation Expression

Symbol error rate=the number of block errors per second/(the number of frames of FEC frame per second×the number of blocks included in one FEC frame)

When the symbol error rate is calculated, the calculation unit 222 converts the symbol error rate into a bit error rate based on a multi-level modulation method (for example, 16 quadrature amplitude modulation (QAM), 64 QAM, or the like), and outputs the bit error rate to the estimation unit 223. By converting the symbol error rate into the bit error rate, the number of BIP errors, which will be described later, may be estimated with higher accuracy than in the case of no conversion. The estimation unit 223 estimates, as the number of BIP errors, the number of bit errors based on the bit error rate, the number of frames of the direct accommodation frame per second, and the number of bits included in one direct accommodation frame. Here, the number of BIP errors is the number of errors based on a parity check. Thus, strictly speaking, the number of BIP errors is different from the number of bit errors. However, since an error rate is extremely small during normal operation, it is assumed that it is acceptable to treat the number of bit errors equivalent to the number of BIP errors and to estimate the number of bit errors as the number of BIP errors.

The reproduction unit 224 reproduces, based on the number of BIP errors estimated by the estimation unit 223, a pseudo frame equivalent to the OTN frame (hereinafter referred to as pseudo frame). For example, as illustrated in FIG. 9, the reproduction unit 224 performs mapping (for example, distributed mapping) of the number of BIP errors onto the pseudo frame, and outputs the pseudo frame to the output unit 225. The pseudo frame includes the number of BIP errors because the number of BIP errors is mapped onto the pseudo frame. In FIG. 9, as an example, the number of BIP errors “1” is mapped to the frame with the frame No (number) “n”. The output unit 225 outputs, based on periodic polling from the quality acquisition unit 231, the number of BIP errors mapped onto the pseudo frame or the pseudo frame itself as information. As described above, since the number of BIP errors and the number of bit errors are treated as equivalent, the number of BIP errors includes the number of bit errors. Therefore, the output unit 225 may output information including the number of bit errors.

Here, as illustrated in FIG. 8, the quality acquisition unit 231 performs periodic polling also on the quality monitor unit 12K of the OTN frame processing unit 12A to acquire quality information including the number of bit errors as the number of BIP errors. On the other hand, as described above, the quality acquisition unit 231 performs periodic polling also on the output unit 225 to acquire the number of BIP errors. In this way, the quality acquisition unit 231 may acquire the number of BIP errors even in the case of the direct accommodation frame, as in the case of the OTN frame.

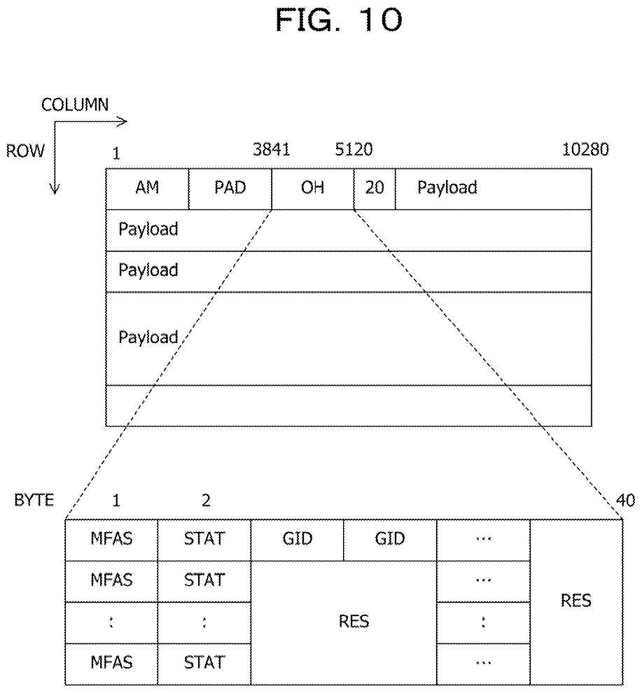

A frame structure of the direct accommodation frame will be described with reference to FIG. 10.

Various items are defined in the direct accommodation frame. For example, as illustrated in an upper part of FIG. 10, OH is defined in columns 3841 to 5120 and payload is defined in columns 5141 to 10280 in a first row at the beginning of the direct accommodation frame. The payload is also defined in columns 1 to 10280 after a second row of the direct accommodation frame. Furthermore, as illustrated in a lower part of FIG. 10, various items are defined also in the OH. For example, in the OH, a multi-frame alignment signal (MFAS) is defined in a first byte (corresponding to the column 3841 in the first row of the direct accommodation frame), and STATUS (STAT) is defined in a subsequent one byte (corresponding to the column 3842 in the same first row).

Since the direct accommodation frame is a transmission frame that directly accommodates a client signal, items that ensure maintainability are limited to the MFAS and the STAT. For example, the direct accommodation frame does not include an item that the OTN frame includes for storing the number of bit errors, and may not be as maintainable as the OTN frame. Thus, it is assumed that the number of bit errors is stored in a RES area, which is one of the items of the OH.

However, even when the number of bit errors is stored in the RES, since the assist unit 220 is slower than the transmission unit 210, even if the assist unit 220 is equipped with the BIP function, it is not possible to transfer the direct accommodation frame from the transmission unit 210 to the assist unit 220 and confirm bit errors. Thus, in the present embodiment, the number of BIP errors is calculated based on the uncorrectable amount acquired by the FEC decoder 11C without storing the number of bit errors in the RES, and the number of BIP errors is confirmed by the control unit 230.

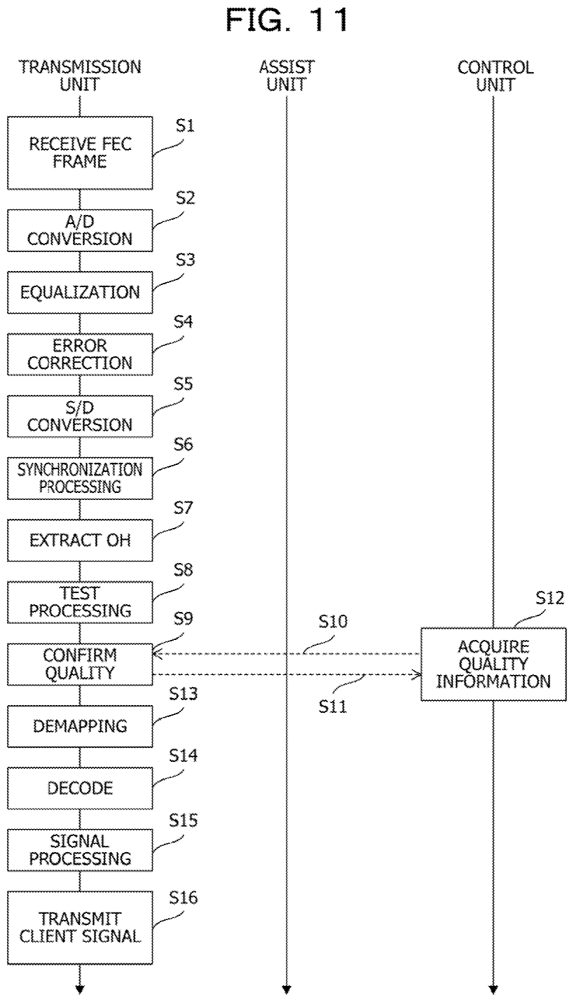

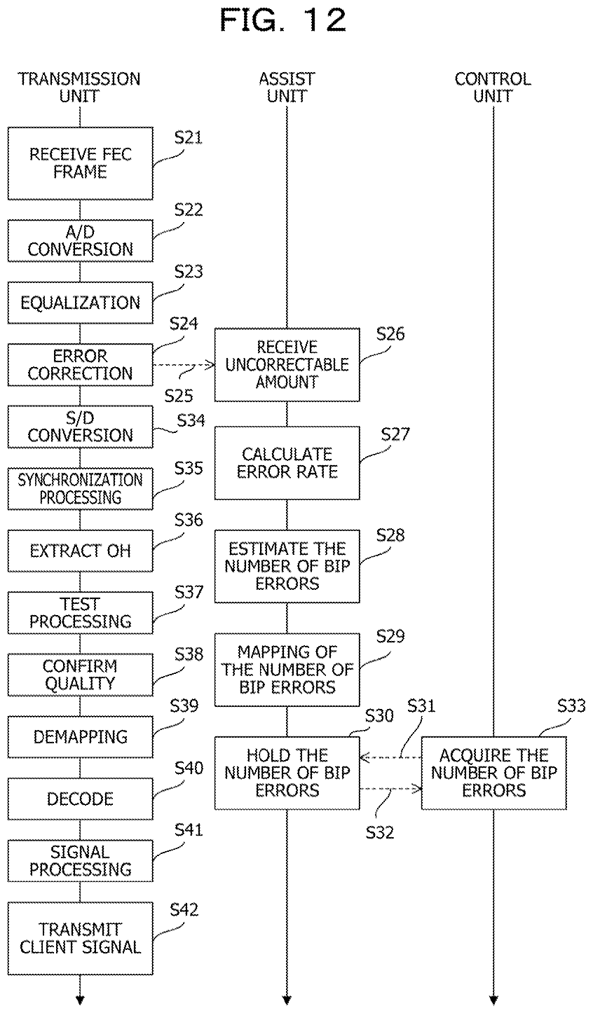

With reference to FIGS. 11 and 12, operation of the optical transmission apparatus 200 for the OTN frame and operation of the optical transmission apparatus 200 for the direct accommodation frame will be described in comparison.

In the case of the OTN frame, as illustrated in FIG. 11, when the optical signal processing unit 211 receives an electrical FEC frame (Step S1), the ADC 11A converts the FEC frame from the analogue format to the digital format (Step S2). When the processing of Step S2 ends, the equalizer 11B compensates the FEC frame for losses caused in the optical transmission apparatus 100 on the transmission side, the optical transmission apparatus 200 on the reception side, and the optical transmission line 300. For example, the equalizer 11B executes equalization processing on the FEC frame (Step S3).

When the processing of Step S3 ends, the FEC decoder 11C performs error correction on the FEC frame (Step S4). When the processing of Step S4 is completed, the SDC 11D converts a plurality of symbols included in the FEC frame after the error correction into data according to the symbols (Step S5). With this configuration, the FEC frame is converted into an OTN frame.

When the processing of Step S5 ends, the signal synchronization unit 12H of the OTN frame processing unit 12A executes synchronization processing on the OTN frame (Step S6). When the processing of Step S6 is completed, the OH extraction unit 12I extracts OH of the OTN frame (Step S7). When the processing of Step S7 is completed, the test function unit 12J executes test processing (Step S8). When the processing of Step S8 is completed, the quality monitor unit 12K confirms quality of the OTN frame (Step S9). At this time, the quality monitor unit 12K detects, by the BIP function, the number of bit errors as the number of BIP errors.

Here, the quality acquisition unit 231 of the control unit 230 executes periodic polling for the quality monitor unit 12K without going through the assist unit 220 (Step S10). When the quality monitor unit 12K detects the polling from the quality acquisition unit 231 after detecting the number of BIP errors, the quality monitor unit 12K outputs quality information including the number of BIP errors and the like to the quality acquisition unit 231 (Step S11). With this configuration, the quality acquisition unit 231 may acquire the quality information (Step S12), and confirm (check) the number of BIP errors.

On the other hand, in the transmission unit 210, when the processing of Step S9 is completed, the demapping unit 12C performs demapping of the OTN frame to a client signal (Step S13). When the processing of Step S13 is completed, the decoding unit 12D decodes, when the client signal is encrypted, the encrypted client signal (Step S14). When the processing of Step S14 is completed, the client signal processing unit 12E executes signal processing (Step S15). For example, the signal synchronization unit 12V executes synchronization processing, the OH extraction unit 12W extracts an OH area of the client signal, the test function unit 12X executes test processing, and the quality monitor unit 12Y confirms quality of the client signal. When the processing of Step S15 is completed, the quality monitor unit 12Y transmits the client signal to the client network (Step S16).

In this way, in the case of the OTN frame, the quality acquisition unit 231 of the control unit 230 acquires the quality information including the number of BIP errors or the like from the quality monitor unit 12K of the transmission unit 210, and confirms the number of BIP errors.

On the other hand, in the case of the direct accommodation frame, as illustrated in FIG. 12, when the optical signal processing unit 211 receives an electrical FEC frame (Step S21), the ADC 11A converts the FEC frame from the analogue format to the digital format (Step S22). When the processing of Step S22 ends, the equalizer 11B executes equalization processing on the FEC frame (Step S23).

When the processing of Step S23 ends, the FEC decoder 11C performs error correction on the FEC frame (Step S24). At this time, the FEC decoder 11C acquires an uncorrectable amount, and outputs the uncorrectable amount to the assist unit 220 (Step S25). With this configuration, the reception unit 221 of the assist unit 220 receives the uncorrectable amount output from the FEC decoder 11C (Step S26).

When the processing of Step S26 is completed, the calculation unit 222 calculates a symbol error rate (Step S27). When the processing of Step S27 is completed, the estimation unit 223 estimates the number of BIP errors (Step S28). When the processing of Step S28 is completed, the reproduction unit 224 performs mapping of the number of BIP errors (Step S29). When the processing of Step S29 is completed, the output unit 225 holds the number of BIP errors (Step S30).

Here, the quality acquisition unit 231 of the control unit 230 executes periodic polling for the output unit 225 of the assist unit 220 (Step S31). When the output unit 225 detects the polling from the quality acquisition unit 231 after holding the number of BIP errors, the output unit 225 outputs error information including the number of BIP errors to the quality acquisition unit 231 (Step S32). With this configuration, the quality acquisition unit 231 may acquire the number of BIP errors via the error information (Step S33), and confirm the number of BIP errors.

On the other hand, in the transmission unit 210, when the processing of Step S24 is completed, the SDC 11D converts a plurality of symbols included in the FEC frame after the error correction into data according to the symbols (Step S34). With this configuration, the FEC frame is converted into a direct accommodation frame.

When the processing of Step S34 ends, the signal synchronization unit 12P of the direct accommodation frame processing unit 12B executes synchronization processing on the direct accommodation frame (Step S35). When the processing of Step S35 is completed, the OH extraction unit 12Q extracts OH of the direct accommodation frame (Step S36). When the processing of Step S36 is completed, the test function unit 12J executes test processing (Step S37). When the processing of Step S37 is completed, the quality monitor unit 12K confirms quality of the direct accommodation frame (Step S38).

When the processing of Step S38 is completed, the demapping unit 12C performs demapping of the direct accommodation frame to a client signal (Step S39). When the processing of Step S39 is completed, the decoding unit 12D decodes, when the client signal is encrypted, the encrypted client signal (Step S40). When the processing of Step S40 is completed, the client signal processing unit 12E executes signal processing (Step S41). When the processing of Step S41 is completed, the quality monitor unit 12Y transmits the client signal to the client network (Step S42).

In this way, in the case of the direct accommodation frame, unlike the OTN frame, the quality acquisition unit 231 of the control unit 230 acquires, from the output unit 225 of the assist unit 220, the number of BIP errors as the error information. With this configuration, the quality acquisition unit 231 may confirm the number of BIP errors via the error information.

As described above, according to the present embodiment, the optical transmission apparatus 200 includes the optical signal processing unit 211 and the assist unit 220. The optical signal processing unit 211 includes the FEC decoder 11C. The FEC decoder 11C performs error correction based on FEC on an FEC frame, and acquires an amount of errors which may not be corrected in the error correction as an uncorrectable amount. On the other hand, the assist unit 220 includes the estimation unit 223 and the output unit 225. The estimation unit 223 estimates the number of bit errors of the errors which may not be corrected in the error correction based on the uncorrectable amount acquired by the FEC decoder 11C. The output unit 225 outputs information including the number of bit errors estimated by the estimation unit 223 as information equivalent to a result of BIP. With these configurations, it is possible to acquire information equivalent to the result of the BIP even for a direct accommodation frame.

Furthermore, in the present embodiment, even the direct accommodation frame may implement a function equivalent to the OTN frame in a pseudo manner. Thus, it is also possible to use a RES area of the direct accommodation frame for another purpose. For example, it is possible to store, in the RES area of the direct accommodation frame, information that is included in the OTN frame but not included in the direct accommodation frame.

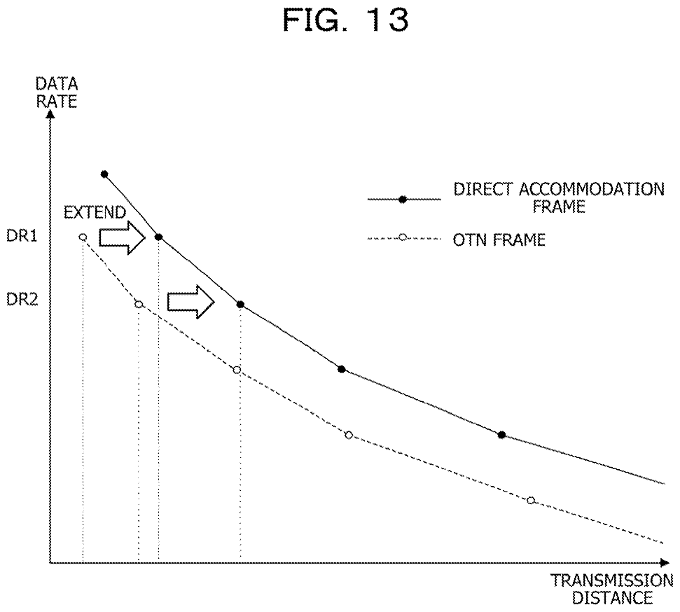

Moreover, as illustrated in FIG. 13, the direct accommodation frame may extend a transmission distance compared to the OTN frame at the same data rate. For example, regardless of whether the data rate is “DR1” or “DR2”, the direct accommodation frame may extend the transmission distance by about several times compared to the OTN frame. Since the direct accommodation frame have a lower redundancy rate than the OTN frame, there is room for adding various types of FEC to the direct accommodation frame. Therefore, when various types of FEC are added by using this room, it is possible to avoid performing error correction in a short distance and reduce a frequency of the error correction. For example, according to the optical transmission apparatus 200 according to the present embodiment, even when the optical transmission apparatus 100 transmits the direct accommodation frame, the transmission distance may be extended beyond the transmission distance of the OTN frame.

Although the preferred embodiment has been described in detail thus far, the present embodiment is not limited to a specific embodiment, and various modifications and alterations may be made within the scope of the gist of the present embodiment described in the claims.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An optical transmission apparatus comprising:
a first processing circuit that performs, on a forward error correction (FEC) frame obtained by adding FEC to a frame that directly accommodates a client signal, error correction based on the FEC, and acquires an amount of errors for which correction failed in the error correction as an uncorrectable amount; and
a second processing circuit that estimates the number of bit errors of the errors based on the uncorrectable amount, and outputs information that includes the estimated number of bit errors.

2. The optical transmission apparatus according to claim 1, wherein the second processing circuit calculates a specific error rate according to the uncorrectable amount based on the uncorrectable amount, the number of frames of the FEC frame, the number of blocks of blocks included in the FEC frame, and a calculation expression that calculates an error rate that is a ratio of the errors for which correction failed in the error correction, and estimates the number of bit errors based on the calculated specific error rate.

3. The optical transmission apparatus according to claim 2, wherein the second processing circuit converts the calculated specific error rate into another error rate in a bit format based on a multi-level modulation method, and estimates the number of bit errors based on the another error rate.

4. The optical transmission apparatus according to claim 1, wherein the first processing circuit acquires, regardless of the number of symbols of symbol errors which occur in symbols included in the FEC frame and for which correction failed in the error correction, the number of blocks of unit blocks that include the symbol errors as the uncorrectable amount.

5. The optical transmission apparatus according to claim 1, wherein the frame includes a frame structure standardized as OpenZR+.

6. The optical transmission apparatus according to claim 1, wherein a processing speed of the first processing circuit is higher than a processing speed of the second processing circuit.

7. An optical transmission method comprising:
performing, on a forward error correction (FEC) frame obtained by adding FEC to a frame that directly accommodates a client signal, error correction based on the FEC, and acquires an amount of errors for which correction failed in the error correction as an uncorrectable amount; and
estimating the number of bit errors of the errors based on the uncorrectable amount, and outputs information that includes the estimated number of bit errors.

8. The optical transmission method according to claim 7, further comprising:
calculating a specific error rate according to the uncorrectable amount based on the uncorrectable amount, the number of frames of the FEC frame, the number of blocks of blocks included in the FEC frame, and a calculation expression that calculates an error rate that is a ratio of the errors for which correction failed in the error correction; and
estimating the number of bit errors based on the calculated specific error rate.

9. The optical transmission method according to claim 8, further comprising:
converting the calculated specific error rate into another error rate in a bit format based on a multi-level modulation method; and
estimating the number of bit errors based on the another error rate.

10. The optical transmission method according to claim 7, further comprising:
acquiring, regardless of the number of symbols of symbol errors which occur in symbols included in the FEC frame and for which correction failed in the error correction, the number of blocks of unit blocks that include the symbol errors as the uncorrectable amount.

11. The optical transmission method according to claim 7, wherein the frame includes a frame structure standardized as OpenZR+.
